(19) United States
(12) Patent Application Publication
(10) Pub. No.: US 2011/0016024 A1
(43) Pub. Date: Jan. 20, 2011

(54) CONSTRUCTION PRODUCT APPROVAL INFORMATION SYSTEM AND METHOD

(76) Inventor: Frank Bennardo, Deerfield Beach, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/835,855

(22) Filed: Jul. 14, 2010

Related U.S. Application Data
(60) Provisional application No. 61/225,384, filed on Jul. 14, 2009.

(51) Int. Cl. G06Q 99/00; G06F 17/30

(52) U.S. Cl. 705/27.1; 707/752; 707/E17.104

(57) ABSTRACT

A computerized system and method for organizing and cataloging product approval data wherein on-line access to such data is provided via a global computer network is disclosed. The system continuously imports data from each approval entity and provides a singular, next generation, information retrieval functions. The system also advances the art of approval information management by allowing manufacturers of approved products the ability to add metadata, which provides additional information to be searched along with product approval data. A significant aspect of the present invention involves providing a search system, available via a global computer network such as the Internet, having the ability to enter, search, use, and most importantly assist in sorting and applying data from the product approvals to assist the user in gaining an accurate understanding of the approved product. Forward and reverse search features “inside” product approvals, product comparisons, and product details are provided. Further features will allow for the searches to be saved and recalled, and provide e-mail notifications to users regarding new products that match search criteria. The present invention provides search page results that also allow highly targeted advertising which can be displayed independent from a manufacturer's product search results.

### CROSS REFERENCE TO RELATED APPLICATIONS

This application claims the benefit of provisional U.S. Patent Application Ser. No. 61/225,384, filed on Jul. 14, 2009.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates generally to the construction industry, and more particularly to an on-line system and method for cataloging construction products that are “approved” for specification by architects and engineers in accordance with local, regional, state, or national building codes such that the products may be easily searched and information downloaded.

2. Description of Related Art

In certain states a manufacturer cannot sell, an engineer/architect cannot specify, and a contractor/homeowner cannot install many products and building components without a registered “product approval”. Thousands of products go into building a structure. For most of such products, particularly those exposed to weather, laws have been adopted to require testing, evaluation, and approval prior to use.

For example, in 1992, Hurricane Andrew devastated south Florida and spurred a revolution in the Florida Construction industry causing Miami Dade County to mandate a product approval system covering some 40 categories of goods. This system included stringent requirements for product certification and quickly grew to be the industry standard not only in Florida, but as a mark of approval throughout the U.S. not only by building officials. In addition, major corporations such as The Home Depot only sell products that are Miami Dade approved in their stores. The “Miami-Dade” approval process and is accepted nationwide as the “gold standard” in product certification.

In 2001, the state of Florida adopted a Statewide Approval System, and local building departments quickly accepted products approved in that system for use in construction. Texas has also developed a similar product approval system under the Texas Department of Insurance. Further, national product certifications are available through the International Code Council (ICC) and the American Architectural Manufacturers Association (AAMA). Miami-Dade county has an index of approvals for almost 40 categories of construction ranging from windows and doors, to fasteners, plumbing fixtures, and fire sprinklers.

Each entity has created their own unique search system to allow construction professionals to search and find approved products. For example, Miami-Dade has an in-house website (http://www.miamidade.gov/buildingcode/pc-search_app.asp) that stores the approval and allows anyone to browse through basic search criteria to find the desired approval for download in PDF format. Users can then download and read the approval, and apply it to their needs. Florida maintains a similar website (http://www.floridabuilding.org/pr/pr₁₃app_srch.aspx) for their approvals. That site includes a handful of primitive search criteria for finding the correct approval.

These sites are used by nearly every contractor, manufacturer, building official, architect, engineer, and industry official in Florida and are used by engineers and architects, both in and out of state, to design work in Florida, but also to help in specifying work elsewhere. Recently ravaged by storms in 2004 and 2005, the states of Louisiana, Mississippi, and Alabama also rely on these product approvals for permitting. As a result, a large number of construction professionals rely on data maintained by these governmental systems, burdened with primitive search capabilities. It is believed that there are over 30,000 approvals among major approval sites with the number growing daily.

The on-line access provided by the controlling government entities, however, have significant limitations that result in making the product approval searches and information retrieval difficult, confusing, inefficient, and time consuming. Such systems forces users to sift through tables and instructions to get simple answers. Information is frequently misunderstood and overlooked. Such inefficiencies cost the construction professional valuable time and money, while resulting in lost bids, product specification and compliance errors, insufficient bids, etc. The information provided and presented by the governing entities has been found to be virtually impossible to interpret by building departments, architects, contractors, engineers, and the general public.

In view of the limitations presented by the on-line databases containing product approval information present in the art, there exists a need for an improved product approval database system.

### BRIEF SUMMARY OF THE INVENTION

The present invention overcomes the limitations and disadvantages present in the art by providing a computerized system and method for organizing and cataloging product approval data wherein on-line access to such data is provided via a global computer network. The system continuously imports data from each approval entity and provides a singular, next generation, information retrieval functions. The system also advances the art of approval information management by allowing manufacturers of approved products the ability to add METADATA, which provides additional information to be searched along with product approval data. A significant aspect of the present invention involves providing a search system, available via a global computer network such as the Internet, having the ability to enter, search, use, and most importantly assist in sorting and applying data from the product approvals to assist the user in gaining an accurate understanding of the approved product. The system further features forward and reverse search features “inside” product approvals, product comparisons, and product details. Further features will allow for the searches to be saved and recalled, and provide e-mail notifications to users regarding new products that match search criteria. The present invention provides search page results that also allow highly targeted advertising which can be displayed independent from a manufacturer's product search results.

### BRIEF DESCRIPTION OF THE SEVERAL VIEWS OF THE DRAWINGS

FIG. 1 is a block diagram generally illustrating a product approval information system in accordance with the present invention;

FIG. 2 is a block diagram illustrating functions and operations within a product approval system in accordance with the present invention; and

FIG. 2 is a flowchart generally illustrating search query and results generation.

### DETAILED DESCRIPTION OF THE INVENTION

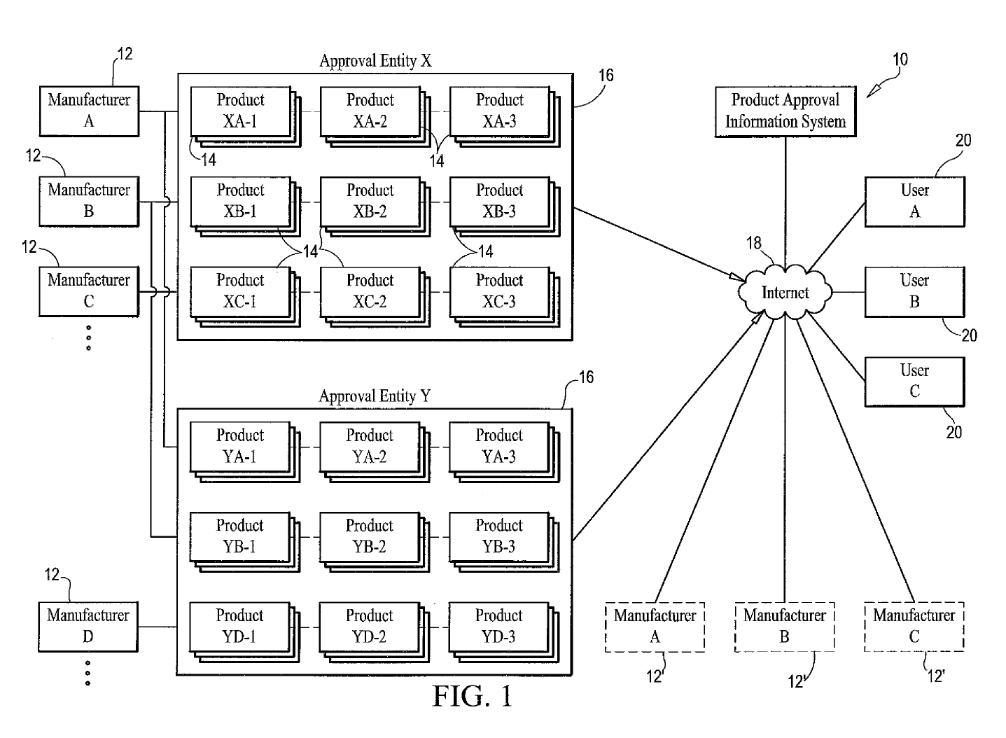

With reference now to the drawings, FIGS. 1-3 illustrate a computerized product approval information system and method, generally referenced as 10, for gathering, organizing, and storing product approval data made available for on-line access by users via a global computer network. Product approval information system 10 functions in accordance with a method that imports data from various approval entities and provides singular, next generation, information retrieval functions to allow users to search and retrieve product approval information in a more efficient manner than may be achieved with product approval information systems known in the art. Product approval and information system 10 further advances the art of approval information management by allowing manufacturers of approved products the ability to add metadata, which provides additional information to be searched along with product approval data.

As best depicted in FIG. 1, a plurality of construction product manufacturers, generally referenced as 12, have products, referenced as 14, approved by various product approval entities, referenced 16. A single manufacturer 12 may have multiple products approved by one or more product approval entities 16. Some products 14 may meet the standards of some, but possibly not all, product approval entities 14. Products 14 comprise a wide variety of construction related goods, such as impact resistant windows and doors, roofing materials, siding materials, screen enclosures, etc. Product approval entities, broadly describes any entity that establishes criteria and product approval requirements. Examples of current product approval entities include: Miami-Dade County; Florida Building Commission, the International Code Council, and the Texas Department of Insurance. Approved products are preferably cataloged and stored in a computer database by each approval entity 16, and searchable on-line access to stored product approvals is typically made available by the product approval entity. Product approval records maintained by the product approval entities may comprise product specifications, including size data, performance criteria, options and accessories. As noted above, product approval records are often cluttered with confusing tables, charts, configuration limitations, which make interpretation of the information time consuming and difficult thereby limiting the efficient dissemination of the information.

The product approval information system 10 functions by accessing and importing publicly available product approval records 14 from the various approval entities 16 via connection over a global computer network, such as the Internet 18. Once the product approval records are accessed, the information is processed and stored and made available for on-line access by users 20 preferably via Internet connection. FIG. 1 illustrates a product approval records 14 obtained by a plurality of manufacturers 12 for one or more approval entities 16. The present invention contemplates obtaining access to said product approval records 14 and incorporating said approval records into a database maintained by the product approval information system of the present invention 10.

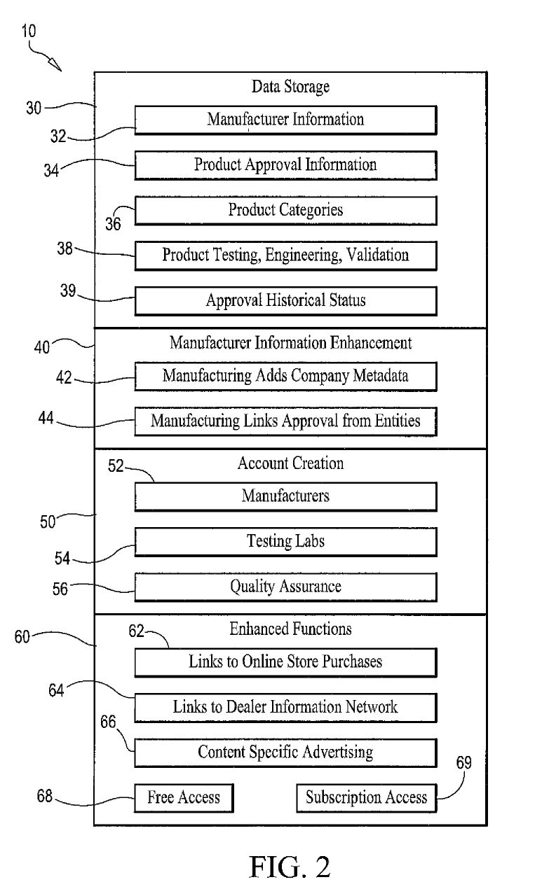

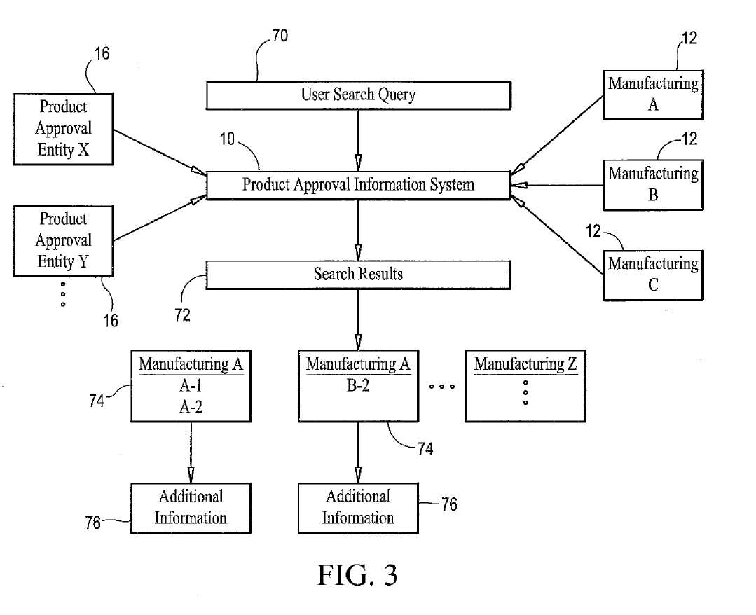

In a preferred embodiment, information is extracted from said product approval records and formatted to simply the use and understanding thereof. For example, data found in complex printed tables may be extracted and formatted into interactive and searchable tables for ease of use. FIG. 2 illustrates processing and storage of product approval data 14 obtained from product approval entities 16. More particularly, system 10 functions to obtain, process, store, and retrieve product approval data records obtained from approval entities 16. More particularly, product approval system 10, incorporates, processes, and stores data using a data storage module, generally referenced as 30. Data storage module 30 stores data extracted from web sites maintained by approval entities 16 corresponding to product approval records 14. More particularly, data storage module 30 stores and combines manufacturer information 32, product approval information 34, product categories 36, product testing, engineering, and validation information 38, and product approval historical data 39. In addition, system 10 includes a manufacturer enhancement module 40, which functions to allow manufacturers 12 to add additional information to product approval records, such as metadata 42 that may include additional product information not found in the approval records 14. As used herein, the term “metadata” shall be broadly construed to mean any data or images relating to the manufacturer, product, or product approval records. A significant aspect of the present invention involves allowing manufacturers to enhance product approval records with metadata, such as sales information, performance claims, warranty information, application variations, product photographs, etc. Manufacture enhancement module 40 further allows the manufacturers to link approvals from various entities 44 to optimize search results. System 10 further includes an account creation module 50, which allows for registration of accounts for manufacturers 52, testing labs, 54, quality assurance entities 56. System 10 further include a number of enhanced functions, generally referenced as 60, which functions allow for creating links to online store purchases 62, links to dealer information networks, 64, the uploading of content specific advertising 66, as well as providing entry gateways for free access 68 and subscription access 69.

FIG. 3 depicts a flow chart which illustrates the product approval system 10 handling of a search query 70. Search query 70 is generated by users 20 and received by product approval information system 10. Search results 72 are generated and search results output 74 wherein acceptable products, from various manufacturers, meeting the search criteria are displayed. In addition to purely reporting products meeting the search criteria, additional information 76, supplied by the manufacturers 12 (such as by the inclusion of Metadata) may be displayed thereby prompting the user to make a buying decision and/or to request further information. A significant aspect of the present invention involves providing a search system, available via a global computer network such as the Internet, having the ability to enter, search, use, and most importantly assist in sorting and applying data from the product approvals to assist the user in gaining an accurate understanding of the approved product. The system further features forward and reverse search features “inside” product approvals, product comparisons, and product details. Further features will allow for the searches to be saved and recalled, and provide e-mail notifications to users regarding new products that match search criteria. The present invention provides search page results that also allow highly targeted advertising which can be displayed independent from a manufacturer's product search results.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A method of importing product approval records from product approval entities, storing the product approval records, and making the records available for on-line access by users via a global computer network, said method including the steps of
importing product approval records from at least one product approval entity, each product approval record including data identifying a product and a product manufacturer;
storing said imported product approval records in a computer database;
providing users with access to said computer database via a global computer network;
allowing users to search for approved products by entering search criteria; and
generating search results corresponding to said search criteria, said search results indentifying product approvals meeting said search criteria.

2. A method according to claim 1, further including the step of allowing manufacturers of approved products to enhance said product approval records with the inclusion of metadata.

3. A method according to claim 1, further including the step of processing said approval records to sort and store manufacturer information, product approval information, product category information, product testing information, engineering data.

4. A method according to claim 1, further including the step of providing subscription based access.

6. A method of importing product approval records from product approval entities, storing the product approval records, and making the records available for on-line access by users via a global computer network, said method including the steps of:
importing product approval records from at least one product approval entity by communication via a global computer network, each product approval record including data identifying a product and a product manufacturer;
storing said imported product approval records in a computer database;
processing said approval records by sorting and storing manufacturer information, product approval information, product category information, product testing information, and engineering data;
allowing product approval records to be enhanced with the addition of metadata;
providing users with access to said computer database via a global computer network;
allowing users to search for approved products by entering search criteria; and
generating search results corresponding to said search criteria, said search results indentifying product approvals meeting said search criteria.

7. A method according to claim 1, further including the step of providing subscription based access.
